(19) United States
(12) Patent Application Publication
(10) Pub. No.: US 2005/0207418 A1
(43) Pub. Date: Sep. 22, 2005

(54) Communication using abbreviated ATM header, especially suitable for use in DSL scenario

(76) Inventors: Zhicheng Tang, Plano, TX (US); Balaji Srinivasan, Allen, TX (US)

Correspondence Address: TEXAS INSTRUMENTS INCORPORATED, P O BOX 655474, M/S 3999, DALLAS, TX, 75265, US

(21) Appl. No.: 10/801,427

(22) Filed: Mar. 16, 2004

(51) Int. Cl. H04L 12/56

(52) U.S. Cl. 370/392; 370/395.1

(57) ABSTRACT

A communication method is based on a communications standard such as, for example, asynchronous transfer mode (ATM), that defines a cell format 110 with a standard header 5 of a standard length M (for ATM, five octets). The method involves forming an abbreviated header 2 of length m<M, and sending a cell 100 including the abbreviated header 2 over a communications medium. In one example, the length of the abbreviated header 2 is two octets, which is substantially less than the five-octet length of a conventional ATM header 5, thus substantially reducing the proportion of cell overhead and increasing communications throughput capability.

### BACKGROUND OF THE INVENTION

1. Field of the Invention

The invention generally relates to arrangements for increasing throughput and bandwidth in data communications. More particularly, the invention relates to arrangements for increasing throughput and bandwidth using asynchronous transfer mode (ATM), especially in digital subscriber line (DSL) scenarios.

2. Related Art

ATM (asynchronous transfer mode) is a communication technology that involves transfer of data in small cells whose sizes are fixed. FIG. 1 element 110 illustrates the format of an ATM cell. ATM cell size is fixed at 53 octets, only 48 (or 90.57%) of which are payload data. Of the 53 octets, a full five octets are devoted to the ATM cell header. Accordingly, 9.43% of the transmission time of ATM cells is consumed by header “overhead” that has no inherent value to the customer who desires to communicate data. Clearly, it would be desirable to increase the proportion of cell space that is occupied by user data, as this would increase overall communication efficiency through reduction of communication overhead. However, despite this recognized and long-felt need, the art had not found a way to reduce the burdensome proportion of overhead in ATM cells.

### SUMMARY

A communication method is based on a communications standard such as, for example, asynchronous transfer mode (ATM), that defines a cell format with a standard header of a standard length M (for ATM, five octets). The method involves forming an abbreviated header of length m<M, and sending a cell including the abbreviated header over a communications medium.

### BRIEF DESCRIPTION OF THE DRAWINGS

A more complete appreciation of the described embodiments is better understood by reference to the following Detailed Description considered in connection with the accompanying drawings, in which like reference numerals refer to identical or corresponding parts throughout, and in which:

FIG. 1 is a diagram comparing conventional ATM cells, to cells with an abbreviated header according to one embodiment;

FIG. 2 is a high-level flowchart illustrating the major phases of an embodiment of a communication method;

FIG. 3 illustrates the training phase 203 of the communication method of FIG. 2;

FIG. 4 illustrates the channel setup phase 204 of the communication method of FIG. 2;

FIG. 5 illustrates the data traffic phase 205 of the communication method of FIG. 2; and

FIG. 6 illustrates the channel shutdown phase 206 of the communication method of FIG. 2.

### DETAILED DESCRIPTION

In describing embodiments illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose. Various terms that are used in this specification are to be given their broadest reasonable interpretation when used to interpret the claims.

Moreover, features and procedures whose implementations are well known to those skilled in the art are omitted for brevity. For example, initiation and termination of loops, and the corresponding incrementing and testing of loop variables, may be only briefly mentioned or illustrated, their details being easily surmised by skilled artisans. Thus, the steps involved in methods described herein may be readily implemented by those skilled in the art without undue experimentation.

Further, various aspects, features and embodiments of the presence indication arrangement may be described as a process that can be depicted as a flowchart, a flow diagram, a structure diagram, or a block diagram. Although a flowchart may describe the operations as a sequential process, many of the operations can be performed in parallel, concurrently, or in a different order than that described. Operations not needed or desired for a particular implementation may be omitted. A process or steps thereof may correspond to a method, a function, a procedure, a subroutine, a subprogram, and so forth, or any combination thereof.

Preliminarily, the following explanations. are provided for abbreviations and acronyms as used in this disclosure, with the understanding that the scope of the claims should not be limited by any particular implementation.

| | |
|---|---|
| ATM | Asynchronous Transfer Mode |
| DSL | Digital Subscriber Line |
| PVC | Permanent Virtual Circuit (or Connection) |
| SVC | Service Virtual Circuit (or Connection) |
| VPI | Virtual Path Identifier |
| VCI | Virtual Channel Identifier |
| CLP | Cell Loss Priority |
| PTI | Payload Type Identifier |
| CPE | Customer Premise Equipment |
| CO | Central Office |
| TC | Transmission Converging |
| Showtime | State in which CPE modem has successfully trained |
| | with CO |
| DSLAM | Digital Subscriber Line Access Multiplexer |
| OAM | Operation, Administration, and Maintenance |
| Compression | Use of an abbreviated header (especially an abbreviated |
| | ATM header, as distinguished from the full five-octet |
| | header) |

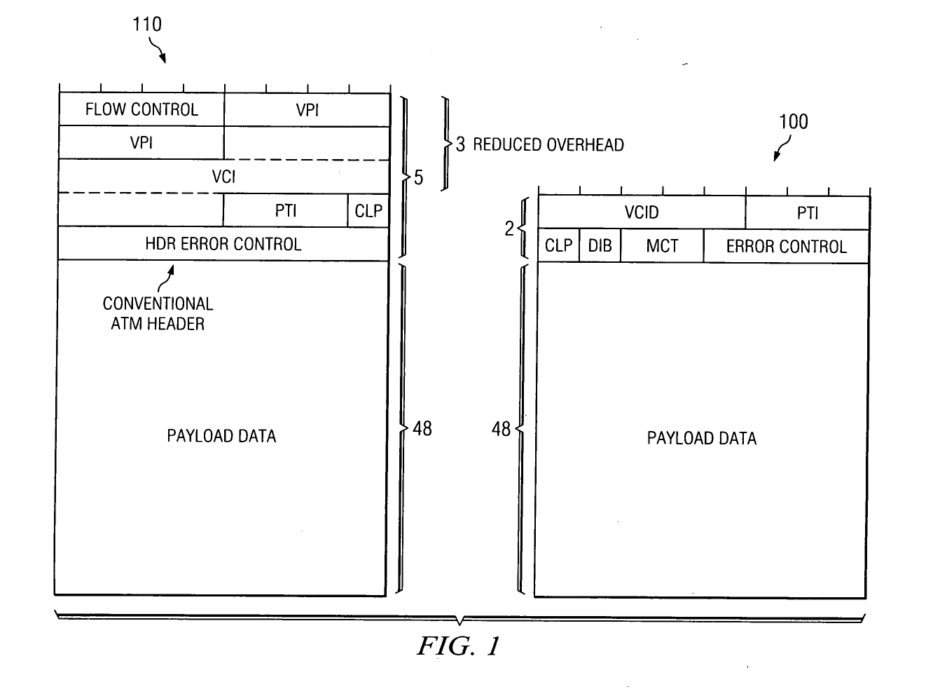

FIG. 1 shows a conventional ATM cell 110 alongside one embodiment of an ATM cell 100 designed in accordance with principles of the present invention. Both cells 100, 110 have 48 octets of payload data. However, cell 100 has only two octets of header, which is only 40% of the five-octet overhead of the conventional ATM cell 110. Accordingly, the abbreviated header of cell 100 reduces the overhead to only 4%, less than half the 9.43% overhead that burdens conventional ATM header 110. Based on this measure, network performance can be increased by a factor of almost six percent (from 90.57% to 96.0% payload data proportion of the cell).

The particular header design 100 involves a five-bit VCID field, a three bit PTI field, a one-bit CLP field, a one-bit DIB field, a two-bit MCT field, and a four-bit Error Control (for example, checksum) field. The meaning and use of these fields is explained below.

Preliminarily, it is emphasized that the scope of the claims should not be limited to the particular fields, field lengths, field arrangements, or field contents, and so forth, shown in FIG. 1. The inventors have recognized that much of the information in the five-octet header of a conventional ATM cell 110 is not required for various given communications scenarios. The way in which the conventional five-octet header may be abbreviated, depends in part on the particular communications scenario. That is, the inventors have recognized that the information from the conventional ATM header that may be safely eliminated (excluded) by abbreviating the header, may be different, for different communications scenarios.

For example, the degree to which a communications scenario reduces the required number of virtual channels, affects the size of a VCID (virtual channel identifier) field. The utility and advantage of the particular two-octet header 100 shown in FIG. 1 derives from an application in the field of digital subscriber line (DSL) communications scenario. DSL may be considered part of the physical layer, and negotiates with and trains the CO to set up a physical layer connection. ATM is the network data carrier layer of system, above the physical layer. Strictly speaking, ATM may be considered independent of DSL, but the DSL layer information exchanges may be used whether or not, in a given circumstance, ATM header compression can be used. For example, in the following description of the VCID field, the number of connections in the underlying layer can be used to determine usability of the present header compression arrangement: lower-level protocols with fewer connections permit greater degrees of header compression to be accomplished. In any event, the scope of the claims should of course not be limited to use with DSL.

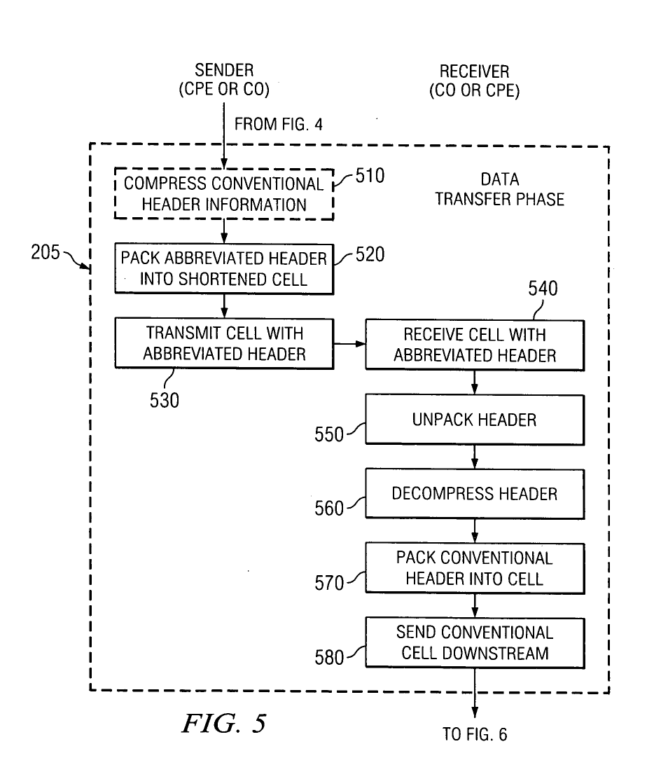

Referring again to FIG. 1, it is apparent that some of the information that is present in the abbreviated header 2 in cell 100 comes from the same source as some of the fields in conventional ATM header 5 in cell 110. However, in consideration of the particular communication scenario (in one embodiment, DSL), much of the information that takes up space in the conventional header 5 can be selectively ignored. The following description illustrates one way in which fields in abbreviated header 2 may be loaded.
VCID (Virtual Channel ID, distinguished from the much longer VCI in the conventional ATM header). DSL typically supports less than 16 (or 32) connections, and accordingly a four-bit (or five-bit) VCID field is sufficient to represent 16 (or 32) connections. The VCID field takes on a value from 0 through 15 (or 31) to uniquely identify the PVC or SVC on which the cell is to be carried. In one embodiment illustrated in FIG. 1, VCID occupies five bits.
PTI (Payload Type Identifier): Comes from the same source, and has the same meaning, as the PTI in conventional ATM header 5. In one embodiment, PTI occupies three bits.
CLP (Cell Loss Priority): Comes from the same source, and has the same meaning, as the CLP in conventional ATM header 5. In one embodiment, CLP occupies one bit.
DIB (Data Identification Bit): a field, which can be a single bit, that takes on a first value (for example 1) to specify that the payload is data, and a second value (for example 0) to specify that the payload is management information. In one embodiment, DIB occupies one bit.
MCT (management cell type): takes on a value that communicates a variety of scenarios or cell definitions. In one embodiment, possible values and their respective meanings are as follows:
   0: Cell is a channel setup notification cell (see FIG. 4 block 4D) or channel close notification cell (see FIG. 6 block 6B);
   1: Cell is an F5 OAM cell (a type of fault management cell at the VCI level);
   2: Cell is an F4 OAM cell, from end-to-end (a type of fault management cell at the VPI level);
   3: Cell is an F4 OAM cell, in the present link (segment) only.

In one embodiment, MCT occupies two bits.
ERROR CONTROL (e.g., CHECKSUM): is an efficient simplification of the Header Error Control field of the conventional ATM header 5. It may involve bit-wise counting of how many of the previous twelve bits in the header are of a certain value (for example, a count of the “density”, or number of “1” bits, in the first twelve bits). Other error control methods are envisioned, such as a “nibble-wise” exclusive OR of the values in first, second and third four-bit “nibbles” preceding the Checksum field. In one embodiment, Checksum occupies four bits.

Keeping in mind the foregoing description of the structure and principles underlying the abbreviated header 2, a communication process that uses the abbreviated header is now described.

Advantageously, the protocol presented in this specification cooperates with existing protocols, including existing ATM protocols. In one application, “compression” (use of an abbreviated or “compressed” header) is handled between an customer premise equipment (CPE) and a central office (CO). Accordingly, use of the abbreviated header does not require any changes to existing systems or protocols beyond the CO's DSLAM (digital subscriber line access multiplexer).

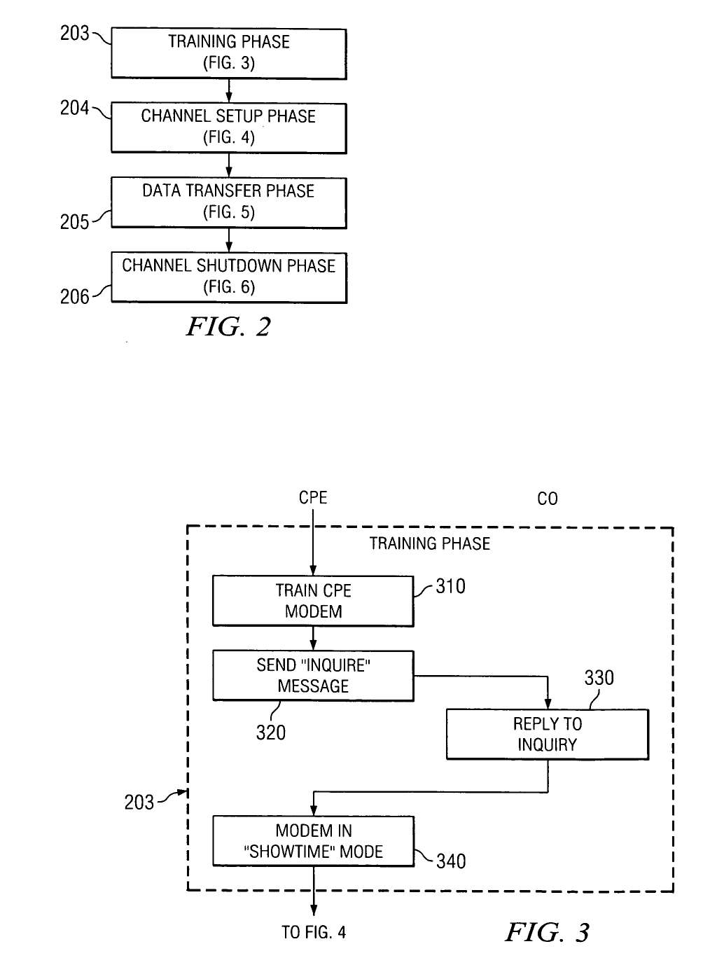

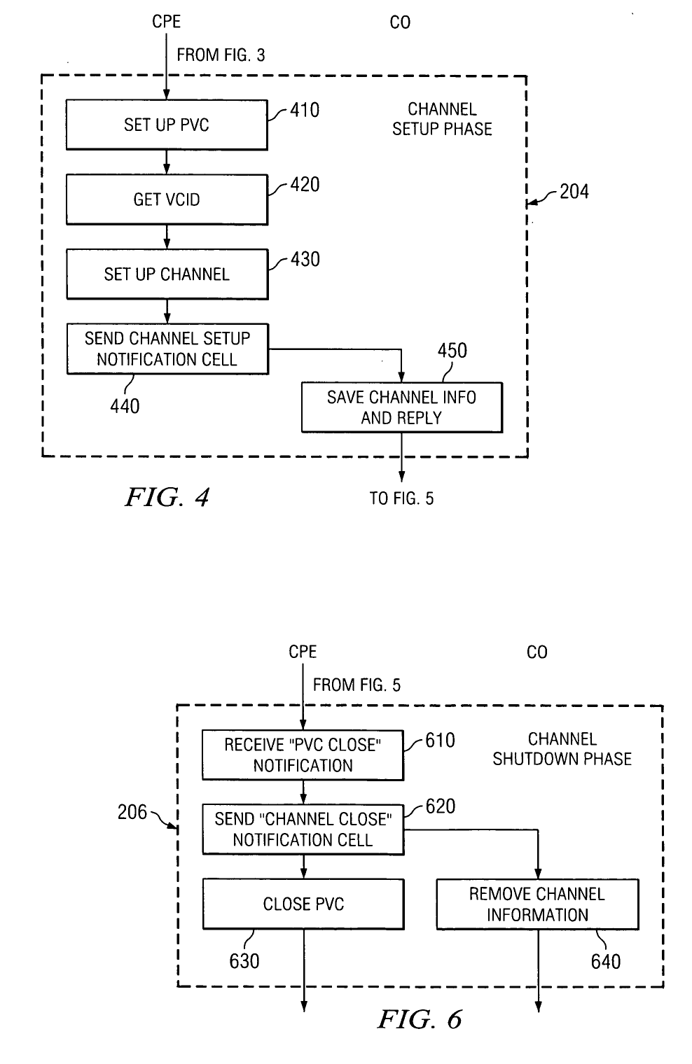

Referring now to FIG. 3, an implementation of block 203 (FIG. 2) is now described.

In FIG. 3, block 310 indicates the training the CPE modem to communicate with the CO modem. This training is carried out as normal, and need not be affected by use of an abbreviated header.

Block 320 indicates how CPE's sending of an “inquire” message to the CO. This inquiry implements how the use of compression (abbreviated header) is negotiated during the training process. Essentially, the CPE is asking the CO if it supports the use of abbreviated headers and is able to in fact do so at the time of the inquiry. Support of the abbreviated header involves at least the ability to synchronize to cells of shorter than conventional length; in the embodiment of cell formats shown in FIG. 1, support of abbreviated headers means the ability to synchronize with 50-octet cells (distinguished from conventional 53-octet ATM cells).

Block 330 indicates the CO's consideration of the CPE's inquiry, and communication back to the CPE that (in this case) the CO is equipped and able to communicate using the abbreviated header. If the CO did not support abbreviated headers, or if it were for some reason unable or unable to carry out communication with abbreviated headers at that particular time, the CO would send back a negative response so that communication would proceed using conventional (unabbreviated) headers.

Block 340 indicates how, after receiving the CO's presumably positive reply, the CPE modem is set into “showtime” mode. As recognized by those skilled in the art, showtime is a mode indicating that the CPE modem has successfully trained with the CO. Thereafter, messages can be exchanged. At this point in our particular example, however, control is assumed to pass to FIG. 4.

Referring to FIG. 4, an implementation of block 204 (FIG. 2) is now described.

In FIG. 4, block 410 indicates how the CPE sets up a permanent virtual channel (PVC).

Block 420 indicates how the virtual channel identifier is read from the VCID field of the first octet of the abbreviated header (see right side of FIG. 1).

Block 430 indicates that the CPE uses the VCID to set up a virtual channel to communicate with the CO.

Block 440 indicates the CPE sending a “channel setup” notification cell to the CO. In a practical embodiment, when a PVC or SVC is opened (4A), the CPE modem would send channel setup notification cells at intervals until the CPE received a response from the CO's DSLAM. The channel setup notification cell includes the specification of the VPI/VCI and other information needed by the CO to adopt the new channel at its end.

Block 450 indicates how, the CO saves the channel information from the received cell, and replies with an affirmative acknowledgement to the CPE. More specifically, upon receiving the channel setup notification cell, the CO's DSLAM records the abbreviated header information, sets a loopback indicator to “on,” and loops back the cell (block 450) to the CPE to confirm the details of the channel that is being set up

Thereafter, control passes to FIG. 5, in which data traffic is carried out.

Referring to FIG. 5, an implementation of block 205 (FIG. 2) is now described. Through out data traffic exchange, conventional ATM headers 5 are replaced by abbreviated (“compressed”) headers 2, such as the example in FIG. 1. Preferably, the abbreviated headers are used in cells being sent both directions, whether originating from the CPE or from the CO. Accordingly, FIG. 5 distinguishes between sender and receiver rather than between CPE and CO, because CPE and CO may take on the role of either sender or receiver.

Block 510 is illustrated in dotted lines to emphasize that it is optional, or may be omitted in certain embodiments and/or under certain circumstances. Often, this decision depends on whether the sender is a CPE or a CO.

Because cells may be originally generated within a CPE, the two-octet header may be assembled directly into a cell that constitutes an abbreviated cell 100; in this event, block 510 may be omitted. Conversely, if for any reason (such as pre-existing software) a conventional five-octet header may already exist at the CPE, then block 510 may be included; a compression step would be needed in order to abbreviate the conventional five-octet header into a two-byte header.

A CO generally serves as a “pass-through” for cells, and accordingly the compression step 510 would often be present. However, its presence is not universally required.

In any event, block 510 indicates how, upon inputting a cell to be transmitted, the sender compresses information from conventional header 5 to form an abbreviated header 2. This compression process may involve mere copying of some fields (such as PTI and CLP), but it may also involve strategic abbreviation of certain fields (VIP/VCI to VCID) or creative generation of fields from other sources (DIB, MCT, Checksum).

Block 520 indicates the sender's packing of the abbreviated header 2 into a cell that is shorter than a cell containing conventional header 5.

Blocks 530 and 540 indicate the transmission and reception of the cell with the abbreviated header.

Upon receiving cells, the receiving entity (presumably the CO but also the CPE) unpacks the header (block 550) and converts (“de-compresses”) the information in the abbreviated header back into a format consistent with reception of conventional ATM headers 5 (block 560). For example, the abbreviated header's VCID field is used to generate suitable values for the virtual path and channel in the conventional header. A conventional ATM header 5 is thus “reconstructed” before the cell is packed into a cell of conventional size (block 570) and passed on to downstream recipients in the ATM network (block 580).

When data traffic is to be concluded, control passes to FIG. 6.

Referring to FIG. 6, an implementation of block 206 (FIG. 2) is now described. In FIG. 6, block 610 indicates the CPE's reception of a “PVC Close” notification, for example, from upper layer software such as configuration and management software.

Block 620 indicates the CPE's sending of a “channel close” notification cell to the Co.

Block 630 indicates that the CPE closes the PVC.

Block 640 indicates that, after receiving the channel close notification cell from the CPE, the CO removes the virtual channel information from its storage location.

Also provided, for the methods described herein, are computer program products (such as storage media) storing program instructions for execution on a computer system having at least one data processing device, which instructions when executed by the computer system cause the computer system to perform the methods described herein.

Further provided are systems for performing the methods described herein, the systems including at least one data processing element. Generally, these data processing elements may be implemented as any appropriate computer(s) employing technology known by those skilled in the art to be appropriate to the functions performed. The computer(s) may be implemented using a conventional general purpose computer programmed according to the foregoing teachings, as will be apparent to those skilled in the computer art. Appropriate software can readily be prepared by programmers based on the teachings of the present disclosure. Suitable programming languages operating with available operating systems may be chosen.

General purpose computers may implement the foregoing methods, in which the computer housing may house a CPU (central processing unit), memory such as DRAM (dynamic random access memory), ROM (read only memory), EPROM (erasable programmable read only memory), EEPROM (electrically erasable programmable read only memory), SRAM (static random access memory), SDRAM (synchronous dynamic random access memory), and Flash RAM (random access memory), and other special purpose logic devices such as ASICs (application specific integrated circuits) or configurable logic devices such GAL (generic array logic) and reprogrammable FPGAs (field programmable gate arrays).

Each computer may also include plural input devices (for example, keyboard, microphone, and mouse), and a display controller for controlling a monitor. Additionally, the computer may include a floppy disk drive; other removable media devices (for example, compact disc, tape, and removable magneto optical media); and a hard disk or other fixed high-density media drives, connected using an appropriate device bus such as a SCSI (small computer system interface) bus, an Enhanced IDE (integrated drive electronics) bus, or an Ultra DMA (direct memory access) bus. The computer may also include a compact disc reader, a compact disc reader/writer unit, or a compact disc jukebox, which may be connected to the same device bus or to another device bus.

The arrangement provides at least one computer readable medium. Examples of computer readable media include compact discs, hard disks, floppy disks, tape, magneto optical disks, PROMs (for example, EPROM, EEPROM, Flash EPROM), DRAM, SRAM, SDRAM.

Stored on any one or on a combination of computer readable media is software for controlling both the hardware of the computer and for enabling the computer to interact with other elements, to perform the functions described above. Such software may include, but is not limited to, user applications, device drivers, operating systems, development tools, and so forth.

Such computer readable media further include a computer program product including computer executable code or computer executable instructions that, when executed, causes a computer to perform the methods disclosed above. The computer code may be any interpreted or executable code, including but not limited to scripts, interpreters, dynamic link libraries, Java classes, complete executable programs, and the like.

From the foregoing, it will be apparent to those skilled in the art that a variety of methods, systems, computer programs on recording media, and the like, are provided.

The present disclosure provides support for a communication method, based on a communications standard that defines a cell format with a standard header of a standard length M, for communicating cells from a sender via a communications medium to a receiver. The method involves forming an abbreviated header of length m<M; and sending a cell, including the abbreviated header, over the communications medium.

The communications standard may be asynchronous transfer mode (ATM), and M may be 5 octets.

The value of m may be 2 octets.

The method may also involve receiving the cell that was sent over the communications medium, and unpacking information from the abbreviated header of length m.

The method may further involve using the unpacked information from the abbreviated header of length m so as to form a standard header of the standard length M, and forming a standard cell including the standard header of the standard length M.

The may also involve sending the standard cell of the standard length M, further downstream from the receiver.

The step of forming an abbreviated header of length m<M may involve (a) forming, within the abbreviated header, a virtual channel identifier (VCID) field that has a VCID field length V<16 bits sufficient to specify a number of virtual channels encountered in a given communications scenario.

The given communications scenario may involve communicating the cells in a digital subscriber line (DSL) network, and V may be less than or equal to 5 bits.

The communications standard may be asynchronous transfer mode (ATM), and the step of forming an abbreviated header of length m<M further may involve (b) forming a PTI (Payload Type Identifier) field as defined in ATM; (c) forming a CLP (Cell Loss Priority) field as defined in ATM; (d) forming a DIB (Data Identification Bit) field that takes on a first value to specify that a cell payload is data, and a second value to specify that the cell payload is management information; (e) forming an MCT (Management Cell Type) field that forms a specification taken from a group including:
a present cell is a channel setup notification cell or a channel close notification cell;
the present cell is an F5 OAM cell;
the present cell is an F4 OAM cell, from end-to-end; and
the present cell is an F4 OAM cell, in the present link (segment) only; and

(f) forming an ERROR CONTROL field.

The method may involve fields in which the PTI field has a PTI length of three bits; the CLP field has a CLP length of one bit; the DIB field has a DIB length of one bit; the MCT field has an MCT length of two bits; and the ERROR CONTROL field has a EC length of four bits.

The given communications scenario may involve communicating the cells in a digital subscriber line (DSL) network, and V may be less than or equal to 5 bits.

The present disclosure further supports a method of forming an abbreviated header of length m<M for incorporation into a cell to be communicated from a sender via a communications medium to a receiver in accordance with a communications standard that defines a standard header of length M. The method may involve collecting information required for fields of the abbreviated header; inserting the information into the abbreviated header of length m; and communicating a cell including the abbreviated header from the sender to the receiver substantially in accordance with the communications standard.

The collecting step may involve reading some of the information from a pre-existing standard header of the standard length M.

The inserting step may involve (a) forming, within the abbreviated header, a virtual channel identifier (VCID) field that has a VCID field length V<16 bits sufficient to specify a number of virtual channels encountered in a given communications scenario.

The given communications scenario may involve communicating the cells in a digital subscriber line (DSL) network, and V may be less than or equal to 5 bits.

The communications standard may be asynchronous transfer mode (ATM), and the inserting step may include (b) forming a PTI (Payload Type Identifier) field as defined in ATM; (c) forming a CLP (Cell Loss Priority) field as defined in ATM; (d) forming a DIB (Data Identification Bit) field that takes on a first value to specify that a cell payload is data, and a second value to specify that the cell payload is management information; (e) forming an MCT (Management Cell Type) field that forms a specification taken from a group including:
a present cell is a channel setup notification cell or a channel close notification cell;
the present cell is an F5 OAM cell;
the present cell is an F4 OAM cell, from end-to-end; and
the present cell is an F4 OAM cell, in the present link (segment) only; and

(f) forming an ERROR CONTROL field.

The method may involve fields such that the PTI field has a PTI length of three bits; the CLP field has a CLP length of one bit; the DIB field has a DIB length of one bit; the MCT field has an MCT length of two bits; and the ERROR CONTROL field has a EC length of four bits.

The present disclosure also supports a communication method, based on a communications standard that defines a cell format with a standard header of a standard length M, involving communicating cells including an abbreviated header of length m<M from a sender via a communications medium to a receiver. The method may involve receiving, from the communications medium, a cell including the abbreviated header of length m<M, and unpacking information from the abbreviated header.

The method may further involve using the unpacked information from the abbreviated header of length m so as to form a standard header of the standard length M, and forming a standard cell including the standard header of the standard length M.

The method may further involve sending the standard cell of the standard length M, further downstream from the receiver.

Moreover, the present disclosure provides support for systems configured to perform any of the above-described methods.

Additionally, the present disclosure provides support for computer program products storing program instructions for execution on a computer system having at least one data processing device, whose instructions when executed by the computer system cause the computer system to perform the methods described herein.

The foregoing embodiments are merely examples and are not to be construed as limiting the invention. The present teachings can be readily applied to other scenarios. The description of the embodiments is intended to be illustrative, and not to limit the scope of the claims. Numerous alternatives, modifications and variations of the present invention are possible in light of the above teachings. For example, the particular length and content of the abbreviated header, the particular arrangement and ordering and length of its fields, the specific manner in which the fields are derived, packed and unpacked, and the particular communications scenario (such as DSL, etc.) may all be varied without departing from the intent of the invention. Of course, the particular hardware or software implementation may be varied while still remaining within the scope of the present invention. It is therefore to be understood that within the scope of the appended claims and their equivalents, the invention may be practiced otherwise than as specifically described herein.

1. A communication method, based on a communications standard that defines a cell format with a standard header of a standard length M, for communicating cells from a sender via a communications medium to a receiver, the method comprising:
forming an abbreviated header of length m<M; and
sending a cell, including the abbreviated header, over the communications medium.

2. The method of claim 1, wherein:
the communications standard is asynchronous transfer mode (ATM); and
M=5 octets.

3. The method of claim 2, wherein:
m=2 octets.

4. The method of claim 1, further comprising:
receiving the cell that was sent over the communications medium; and
unpacking information from the abbreviated header of length m.

5. The method of claim 4, further comprising:
using the unpacked information from the abbreviated header of length m so as to form a standard header of the standard length M; and
forming a standard cell including the standard header of the standard length M.

6. The method of claim 5, further comprising:
sending the standard cell of the standard length M, further downstream from the receiver.

7. The method of claim 1, wherein the step of forming an abbreviated header of length m<M includes:
a) forming, within the abbreviated header, a virtual channel identifier (VCID) field that has a VCID field length V<16 bits sufficient to specify a number of virtual channels encountered in a given communications scenario.

8. The method of claim 7, wherein:
the given communications scenario involves communicating the cells in a digital subscriber line (DSL) network; and
V≦5 bits.

9. The method of claim 7, wherein the communications standard is asynchronous transfer mode (ATM), and the step of forming an abbreviated header of length m<M further includes:
b) forming a PTI (Payload Type Identifier) field as defined in ATM;
c) forming a CLP (Cell Loss Priority) field as defined in ATM;
d) forming a DIB (Data Identification Bit) field that takes on a first value to specify that a cell payload is data, and a second value to specify that the cell payload is management information;
e) forming an MCT (Management Cell Type) field that forms a specification taken from a group including:
a present cell is a channel setup notification cell or a channel close notification cell;
the present cell is an F5 OAM cell;
the present cell is an F4 OAM cell, from end-to-end; and
the present cell is an F4 OAM cell, in the present link (segment) only; and
f) forming an ERROR CONTROL field.

10. The method of claim 9, wherein:
the PTI field has a PTI length of three bits;
the CLP field has a CLP length of one bit;
the DIB field has a DIB length of one bit;
the MCT field has an MCT length of two bits; and
the ERROR CONTROL field has a EC length of four bits.

11. The method of claim 10, wherein:
the given communications scenario involves communicating the cells in a digital subscriber line (DSL) network; and
V≦5 bits.

12. A method of forming an abbreviated header of length m<M for incorporation into a cell to be communicated from a sender via a communications medium to a receiver in accordance with a communications standard that defines a standard header of length M, the method comprising:
collecting information required for fields of the abbreviated header;
inserting the information into the abbreviated header of length m; and
communicating a cell including the abbreviated header from the sender to the receiver substantially in accordance with the communications standard.

13. The method of claim 12, wherein the collecting step includes:
reading some of the information from a pre-existing standard header of the standard length M

14. The method of claim 12, wherein the inserting step includes:
a) forming, within the abbreviated header, a virtual channel identifier (VCID) field that has a VCID field length V<16 bits sufficient to specify a number of virtual channels encountered in a given communications scenario.

15. The method of claim 14, wherein:
the given communications scenario involves communicating the cells in a digital subscriber line (DSL) network; and
V≦5 bits.

16. The method of claim 14, wherein the communications standard is asynchronous transfer mode (ATM), and the inserting step includes:
b) forming a PTI (Payload Type Identifier) field as defined in ATM;
c) forming a CLP (Cell Loss Priority) field as defined in ATM;
d) forming a DIB (Data Identification Bit) field that takes on a first value to specify that a cell payload is data, and a second value to specify that the cell payload is management information;
e) forming an MCT (Management Cell Type) field that forms a specification taken from a group including:
a present cell is a channel setup notification cell or a channel close notification cell;
the present cell is an F5 OAM cell;
the present cell is an F4 OAM cell, from end-to-end; and
the present cell is an F4 OAM cell, in the present link (segment) only; and
f) forming an ERROR CONTROL field.

17. The method of claim 16, wherein:
the PTI field has a PTI length of three bits;
the CLP field has a CLP length of one bit;
the DIB field has a DIB length of one bit;
the MCT field has an MCT length of two bits; and
the ERROR CONTROL field has a EC length of four bits.

18. A communication method, based on a communications standard that defines a cell format with a standard header of a standard length M, involving communicating cells including an abbreviated header of length m<M from a sender via a communications medium to a receiver, the method comprising:
receiving, from the communications medium, a cell including the abbreviated header of length m<M; and
unpacking information from the abbreviated header.

19. The method of claim 18, further comprising:
using the unpacked information from the abbreviated header of length m so as to form a standard header of the standard length M; and
forming a standard cell including the standard header of the standard length M.

20. The method of claim 19, further comprising:
sending the standard cell of the standard length M, further downstream from the receiver.

21. A system configured to perform the method of claim 1.

22. A system configured to perform the method of claim 3.

23. A system configured to perform the method of claim 7.

24. A system configured to perform the method of claim 12.

25. A system configured to perform the method of claim 14.

26. A system configured to perform the method of claim 18.

27. A computer program product storing program instructions for execution on a computer system having at least one data processing device, whose instructions when executed by the computer system cause the computer system to perform the method of claim 1.

28. A computer program product storing program instructions for execution on a computer system having at least one data processing device, whose instructions when executed by the computer system cause the computer system to perform the method of claim 3.

29. A computer program product storing program instructions for execution on a computer system having at least one data processing device, whose instructions when executed by the computer system cause the computer system to perform the method of claim 7.

30. A computer program product storing program instructions for execution on a computer system having at least one data processing device, whose instructions when executed by the computer system cause the computer system to perform the method of claim 12.

31. A computer program product storing program instructions for execution on a computer system having at least one data processing device, whose instructions when executed by the computer system cause the computer system to perform the method of claim 14.

32. A computer program product storing program instructions for execution on a computer system having at least one data processing device, whose instructions when executed by the computer system cause the computer system to perform the method of claim 18.
